(19) United States
(12) Patent Application Publication
(10) Pub. No.: US 2013/0018827 A1
(43) Pub. Date: Jan. 17, 2013

(54) SYSTEM AND METHOD FOR AUTOMATED LABELING OF TEXT DOCUMENTS USING ONTOLOGIES

(71) Applicants: Jingrui He, Ossining, NY (US); Richard D. Lawrence, Ridgefield, CT (US); Prem Melville, White Plains, NY (US); Vikas Sindhwani, Hawthorne, NY (US); Vijil E. Chenthamarakshan, Ossining, NY (US)

(72) Inventors: Jingrui He, Ossining, NY (US); Richard D. Lawrence, Ridgefield, CT (US); Prem Melville, White Plains, NY (US); Vikas Sindhwani, Hawthorne, NY (US); Vijil E. Chenthamarakshan, Ossining, NY (US)

(73) Assignee: INTERNATIONAL BUSINESS MACHINES CORPORATION, Armonk, NY (US)

(21) Appl. No.: 13/184,156

(22) Filed: Jul. 15, 2011

(51) Int. Cl. G06F 15/18; G06N 5/02

(52) U.S. Cl. 706/12; 706/46

(57) ABSTRACT

A first mapping function automatically maps a plurality of documents each with a concept of ontology to create a documents-to-ontology distribution. An ontology-to-class distribution that maps concepts in the ontology to class labels, respectively, is received, and a classifier is generated that labels a selected document with an associated class identified based on the documents-to-ontology distribution and the ontology-to-class distribution.

### FIELD

The present application relates generally to computers, computer applications, and document processing, and more particularly to labeling of documents using ontologies.

### BACKGROUND

The explosion of user-generated content by way of blogs and social networking sites has given rise to a host of different applications of text categorization, collectively referred to as Social Media Analytics, to glean insights from this sea of text (P. Melville, V. Sindhwani, and R. Lawrence. Social media analytics: Channeling the power of the blogosphere for marketing insight. In Proc. of the Workshop on Information in Networks, 2009). The very dynamic nature of social media presents the added challenge of requiring many classifiers to be built on the fly, e.g., building a classifier to identify relevant tweets on the latest smartphone fad, which may be critical for marketing and public relations. As performance of automatic text categorization methods is gated by the amount of supervised data available, there have been many directions explored to get the most out of the available data and human effort.

Current methods for machine learning depend on large amounts of labeled training data. For instance, active learning, semisupervised learning, transfer learning and multi-task learning are some of the different approaches presented for automatic document classification using machine learning. Those approaches rely on human experts providing labels for individual examples or features. For example, some of the approaches are described as (1) exploiting unlabeled data through semi-supervised learning (O. Chapelle, B. Schoelkopf, and A. Zien. Semi-supervised Learning. MIT Press, Cambridge, Mass., 2005.), (2) having the learner select informative examples to be labeled via active learning (B. Settles. Active learning literature survey. Computer Sciences Technical Report 1648, University of Wisconsin—Madison, 2009), (3) alternative forms of supervision, such as labeling features (G. Druck, G. Mann, and A. McCallum. Learning from labeled features using generalized expectation criteria. In SIGIR, 2008), (4) learning from data in related domains through transfer learning (J. Blitzer, M. Dredze, and F. Pereira. Biographies, bollywood, boom-boxes and blenders: Domain adaptation for sentiment classification. In ACL, 2007), and (5) guided learning, where human oracles use their domain expertise to seek instances representing the interesting regions of the problem space (J. Attenberg and F. Provost. Why label when you can search?: alternatives to active learning for applying human resources to build classification models under extreme class imbalance. In KDD, 2010). All of these approaches still rely on human experts providing labels for individual examples or features, and improve with more labels.

### BRIEF SUMMARY

A system for automated labeling of documents using ontology, in one aspect, may include a first mapping function for automatically mapping a plurality of documents each with a concept of ontology to create a documents-to-ontology distribution. The system may also include a second mapping function that maps concepts in the ontology to class labels and creates an ontology-to-class distribution. The system may further include a classifier that labels a selected document with an associated class label automatically, based on the documents-to-ontology distribution and the ontology-to-class distribution.

A method for automated labeling of documents using ontology, in one aspect, may include mapping automatically a document with a concept in ontology, receiving an ontology concepts-to-class label mapping, and labeling the document with a class label automatically, by identifying a class associated with the concept in the ontology, based on the ontology concepts-to-class label mapping.

Yet in another aspect, a computer-implemented method for automated labeling of documents using ontology, may include generating a first mapping function for automatically mapping a plurality of documents each with a concept of ontology to create a documents-to-ontology distribution. The method may further include receiving an ontology-to-class distribution that maps concepts in the ontology to class labels, respectively, and generating a classifier that labels a selected document with an associated class identified based on the documents-to-ontology distribution and the ontology-to-class distribution.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram illustrating an automated labeling based on ontologies in one embodiment of the present disclosure.

FIG. 2 is an illustrative example showing the unsupervised mapping of terms in a document to part of an ontology in one embodiment of the present disclosure.

### DETAILED DESCRIPTION

The present disclosure in one embodiment describes an approach to highly scalable supervision, where a very small fixed amount of human effort can be translated to supervisory information on many unlabeled examples, at no additional cost. A framework in one embodiment of the present disclosure may extract supervisory information from ontologies, for instance, available on Web 2.0 platforms, and complement it with a shift in human effort from direct labeling of examples in the domain of interest to the more efficient identification of concept-class associations.

The approach to scalable supervision in one embodiment of the present disclosure may utilize knowledge-bases and ontologies, generated through collective human effort or semi-automatic processes, such as Wikipedia™, Word Net™ and the Gene Ontology™. While these ontologies may not have been constructed with a specific classification task in mind, the vast amounts of domain specific and/or general knowledge can be exploited to improve building of supervised models for a given task. Unlike the traditional supervised learning paradigm, in which supervisory information is provided by labeling examples, and classifiers are induced using such labeled examples, the methodologies of the present disclosure in one embodiment may provide “concept labeling”, where instead of labeling individual examples, the user provides a mapping between concepts in an ontology to the target classes of interest. The methodologies of the present disclosure in one embodiment then may map unlabelled examples to concepts in an ontology. The process of mapping unlabeled documents (examples) into concepts in an ontology can be fully-automated, e.g., mapping keywords in a document to corresponding Wikipedia™ entries. Thus instead of labeling individual documents, human effort may be better spent on labeling concepts in the ontology with the classes of interest, e.g., mapping the Wikipedia™ categories oncology and anatomical pathology to the medical publication class on neoplasm.

The methodologies of the present disclosure in one embodiment may reduce manual labeling efforts. Instead of labeling individual documents or features, the user provides a handful of mapping between classes and concepts in ontology. A large number of training examples may be automatically labeled with constant effort. The labeling task may be performed by a user who is minimally familiar with domain.

Most unlabeled documents can be automatically mapped to concepts in a given ontology; the methodologies of the present disclosure in one embodiment may use the few provided concept labels to then automatically label available unlabeled documents. The cost of labeling may be also reduced, since there would only be one time fixed cost of providing ontology-to-class mappings via concept labels. Once the methodologies of the present disclosure automatically generate ontology-based labeled documents, the methodologies of the present disclosure may apply any text categorization method of choice to build a classifier that generalizes to unseen (test) documents.

It is noted that “concept labeling” of the present disclosure is different from the known approaches of using ontologies in classification, which have focused on enhancing the existing instance representation with new ontology-based features, and for example, described in E. Gabrilovich and S. Markovitch. Overcoming the brittleness bottleneck using Wikipedia: enhancing text categorization with encyclopedic knowledge. In AAAI, 2006. Instead, the methodologies of the present disclosure may provide for different and another use of human annotation effort in labeling concepts in an ontology, which may be more cost-effective than labeling documents, and induce higher accuracy classifiers than several other approaches.

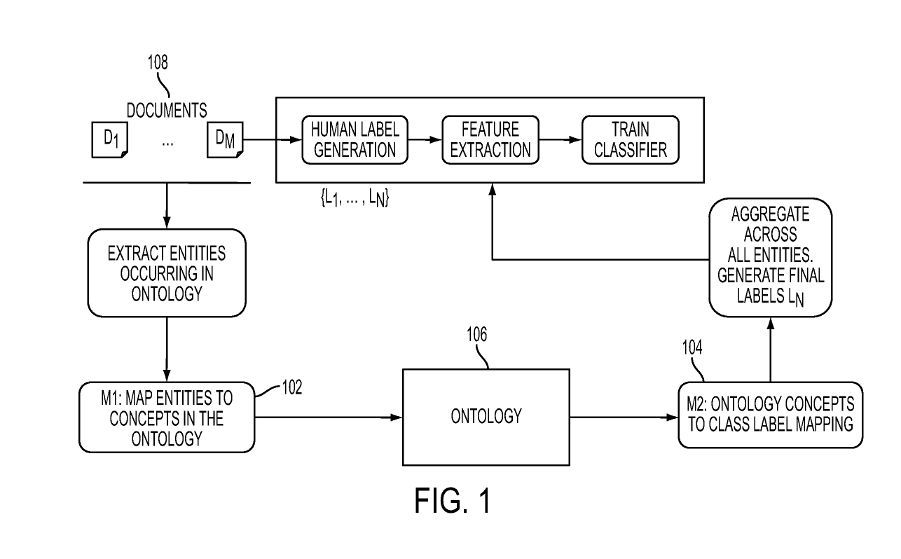

FIG. 1 is a diagram illustrating an automated labeling based on ontologies in one embodiment of the present disclosure. A function herein referred to as a first function or M1 is generated that maps training documents to be labeled to concepts in ontology. The user provides another function, herein referred to as a second function or M2 that maps concepts in the ontology to class labels. Instead of the user directly labeling each document, the first function M1 automatically maps a document to a concept in the ontology. Then the second function M2 maps the ontology concepts to class labels. A document may be labeled with class label, based on the documents to ontology mapped by M1 and ontology to classes mapped by M2.

In one embodiment of the present disclosure, in order to map the documents to an ontology, entities occurring in the ontology are extracted from documents 108 as shown at 110. M1 102 in one embodiment may identify entities from a document that occur in the ontology. A named entity extractor may be employed for identifying the entities (e.g., keywords) from the document and which have been labeled as belonging to a class of interest. Examples of named entity extractors include GATE (General Architecture for Text Engineering) and System T from International Business Machines Corporation (IBM) of Armonk, N.Y. The ontology labels of each entity hence identified are analyzed, and the class label that occurs most frequently in the document (based on M2) is returned as the class label of the document. In one embodiment of the present disclosure, each document could get mapped to multiple concepts in the ontology. Then, the methodology of the present disclosure may identify the class associated with each concept. The class that occurs most frequently across all concepts hence identified is taken as the class label of the document.

A large number of documents, {dᵢ}ᵢ₌₁ⁿ, may be collected by an automated process such as a web crawler. Given a document d, it may be assumed that there is an unknown true conditional distribution P(y|d) over binary categories, y ∈ {−1,1}. Here, y represents a particular instance of a class. The method of the present disclosure may also generalize to multiclass problems. By human annotation effort, a small subset of documents may be labeled by sampling yᵢ˜P(y|dᵢ), i=1. . . l, where the number of labeled documents, l, is typically much smaller than the total number of documents collected. Next, a representation for documents is chosen. Let ψ_{bow}(d) represent the popular bag-of-words representation for document d. A supervised learning model may be set up as a proxy for the underlying true distribution. Such a model may broadly be specified as follows,

P(y|d)=p(y|ψ_{bow}(d), α) (1)

where the model parameters α are tuned to fit the labeled examples while being regularized to avoid overfitting. The dominant cost and the primary bottleneck in this end-to-end process is the collection of human labeled data.

In the present disclosure in one embodiment, an available ontology O=(V, E, Ψₒₙₜ) is formalize in terms of a triplet: (i) a set of concepts V, (ii) a graph of directed edges E that captures inter-relationships between concepts, i.e., an edge (v₁, v₂ ∈ E) indicates that v₂ is a sub-concept of v₁, and (iii) a feature function ψₒₙₜ that associates each concept in V to a set of numerical attributes. In one embodiment of the present disclosure, it may be assumed that categories are conditionally independent of documents, given the concepts of the ontology. In other words, instead of Eq. 1, Eq. 2 as follows may be generated.

$${P}_{ont} ( y \vert d ) = {\sum }_{v ∈ V} p ( y , v \vert d ) = {\sum }_{v ∈ V} P ( v \vert d ) P ( y \vert v , β ) \qquad ( 2 )$$

P(v|d) is referred to as the Documents-to-Ontology distribution, and P(y|v, β) as the Ontology-to-Class distribution. These distributions are modeled separately in the framework of the present disclosure in one embodiment and take the graph structure of the ontology into account.

The present disclosure in one embodiment presents an unsupervised construction of the documents-to-ontology distribution, but a supervised construction of the ontology-to-class distribution. Human effort is shifted in supplying a labeled set {vᵢ, yᵢ}ᵢ₌₁^{l} where yᵢ˜P(y|vᵢ). The model parameters β are learnt using labeled data while respecting concept relationships.

Documents-to-Ontology Distribution

A methodology of the present disclosure in one embodiment defines a feature function ψₒₙₜ, for instance, as part of the specification of an Ontology. The feature function may extract a set of attributes for any given concept v, as well as any given document d. Examples of concepts or attributes of concepts include “Biology”, “Physics”, “Smartphones”, “National Football League”, and others. Examples of documents include a web page, a legal document, a tweet, a newspaper article, and others. The role of ψₒₙₜ in one embodiment is to provide a feature space in which the similarity between documents and concepts can be measured. Let Nₖ(v) denote the k-neighborhood of the concept v, i.e., the set of concepts connected to v by a path of length up to k, comprising of directed edges in E. The documents-to-ontology distribution may be defined as follows,

$$P ( v \vert d ) α {\sum }_{q ∈ {N}_{k} ( v )} {{ψ}_{ont} ( d )}^{T} {ψ}_{ont} ( q ) \qquad ( 3 )$$

In Eq. (3) q represents concepts in the k-neighorhood of v. Note that this distribution naturally takes the graph structure of concepts into account. The definition of ψₒₙₜ is domain/task independent and specifies a general procedure to match documents against the ontology. This step is the unsupervised component of the framework of the present disclosure. Note that implicit in the definition above is the assumption that document d is not orthogonal to all the concepts v ∈ V, with respect to the feature space induced by ψₒₙₜ. This assumption allows similarity scores to be correctly normalized into a probability distribution.

Ontology-to-Class Distribution

In one embodiment of the present disclosure, the ontology-to-class distribution is estimated from a labeled sample {vᵢ, yᵢ}ᵢ₌₁^{l} and is the only component of the present disclosure in one embodiment where human supervision is expected. In comparison to reading, comprehending and labeling documents, the rapid identification of concept-class associations can be a much more effortless and time-efficient exercise. The task of labeling graphs from partial node labeling has received recent attention in machine learning, with regularization frameworks to handle both undirected (M. Belkin, I. Matveeva, and P. Niyogi. Regularization and semi-supervised learning on large graphs. In COLT, 2004) and directed cases (D. Zhou, J. Huang, and B. Schoelkopf. Learning from labeled and unlabeled data on a directed graph. In ICML, 2005). These methods may be seen as smooth diffusions or random-walk based propagation of labeled data along the edges of the graph. In particular, let p be a vector such that pᵢ=P(y=1|vᵢ). The parameters β in Eq. 2 can be identified with p. Then one can solve the following optimization problem,

$${p}^{*} = {argmin}_{p} - \frac{1}{l} \sum log [ {{p}_{i}^{\frac{1 + {v}_{i}}{2}} ( 1 - {p}_{i} )}^{\frac{1 - {v}_{i}}{2 }} ] + γ {p}^{T} Lp$$

$$subject to \text{:} 0 \leq {p}_{i} \leq 1 , i = 1 … \vert V \vert$$

where the first term is negative log-likelihood and the second term measures smoothness of the distribution with respect to the ontology as measured using the Laplacian matrix (D. Zhou, J. Huang, and B. Schoelkopf. Learning from labeled and unlabeled data on a directed graph. In ICML, 2005) of the directed graph (V,E) with γ>0 as a real-valued regularization parameter.

In one embodiment, the methodology of the present disclosure in one embodiment may use is a “hard” label propagation where P(y=1|v)=1 for all v exclusively in the neighborhood of a positively labeled concept node, P(y=−1|v)=1 for all v exclusively in the neighborhood of a negatively labeled concept node, and P(y=1|v)=0.5 for the remaining concepts.

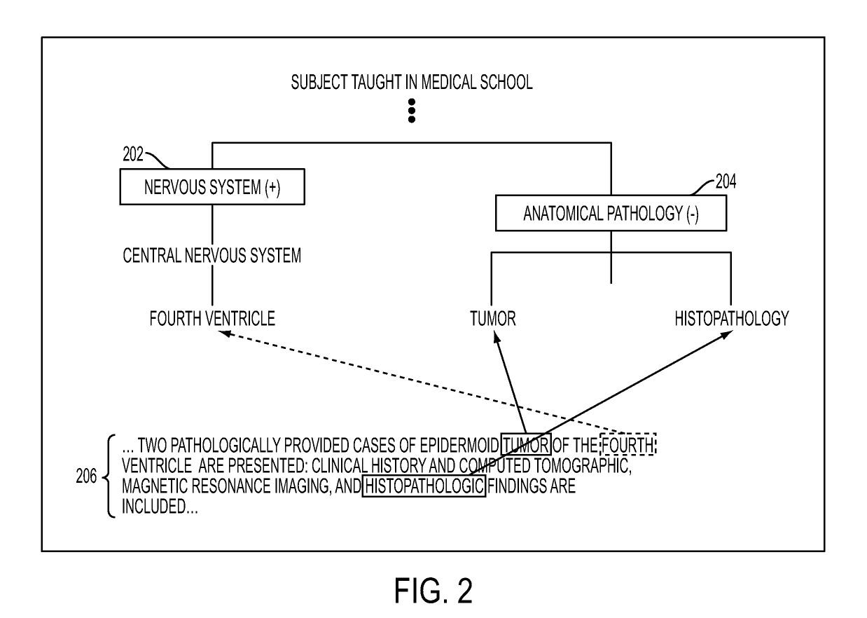

As an example, each node in the ontology is considered a concept. Hence the entire ontology provides a database of concepts. For example, in FIG. 2 in the document mentioned, two terms map to the Anatomical Pathology concept and one term maps to the Nervous System concept. Since in this example, Anatomical Pathology concept was given the class label “Neoplasm” by M2 mapping function, the document will be labeled as Neoplasm class.

In one embodiment of the present disclosure, each document is mapped to a concept. The labels assigned to the mapped concept are used to arrive at a label for the document.

Final Classifier Induction from Unlabeled Data

The steps described above allow a documents-to-class distribution to be estimated with low-cost concept-level supervision. In one embodiment of the present disclosure, an ontology-based classifier may be defined as follows:

$$O ( d ) = {argmax}_{y ∈ \{ - 1 , \_ + 1 \}} {P}_{ont} ( y \vert d ) \qquad ( 4 )$$

Note that if P_{ony}(y=1|d)=Pₒₙₜ(y=−1|d)=0.5, then O(d) is not uniquely defined. This can happen, for example, when P(v|d)>0 implies P(y=1|v)=P(v=−1|v), i.e, the document d matches concepts where the class distributions are evenly split. Documents for which the distribution in Eq. 3 cannot be properly defined, or for which 0(d) is not uniquely defined are considered out of coverage. Let C be the set of documents that have coverage. The entire original unlabeled collection can be taken, {dᵢ}ᵢ₌₁ⁿ and generate a labeled set {(dᵢ, O(dᵢ)): dᵢ ∈ C}. The final step of the framework of the present disclosure in one embodiment may use this labeled set, obtained using concept labeling instead of direct document labeling, to train a classifier via Eq. 1. This is done for the following reasons: (1) this allows generalization to test documents that are not covered by the ontology-based classifier (Eq. 4), and (2) even if the ontology-based classifier only weakly approximates the true underlying Bayes optimal classifier, the labels it generates can induce a strong classifier in the bag-of-words representation. This is because highly domain-specific word dependencies with respect to classes, not represented in ontology-specific attributes, may be picked up during the process of training. The traditional process of document labeling is contrasted with the present disclosure's concept-labeling framework. The direct use of Eq. (4) is referred to as ontology-based classification.

In text classification, a small number of documents (called the training set) are provided with labels. These labeled documents are used to train a classifier. The trained classifier can be used to predict the label of unseen documents.

A text categorization system may implement the framework of the present disclosure. An example text categorization system may use the English-only subset of Wikipedia™. As a directed graph, the Wikipedia™ Ontology comprises of about 4.1 million nodes with more than 20 million edges. About 85% of the nodes do not have any subcategories and are standalone concepts. Each concept has an associated webpage with a title and a detailed text description. The feature map ψₒₙₜ may be set up with the vocabulary space of |V| concept titles. For any concept v, a binary vector ψₒₙₜ (v) may be defined which is valued 1 for the title of v and 0 otherwise. For any document d, the vector ψₒₙₜ (d) is a “bag-of-titles” frequency vector obtained by indexing d over the space of concept titles. The bag of titles frequency vector contains the frequency of each word. Though a document has only one title, it could contain multiple words. The indexing is robust to minor phrase variations, i.e., any unigram, bigram or trigram token that redirects to a Wikipedia™ page is indexed against the title of that page. Then, the documents-to-ontology distribution, Eq. 3, P(v|d), is proportional to the number of occurrences of titles in the document for all concepts in the neighborhood of v. This unsupervised step of mapping documents onto the ontology is schematically shown in FIG. 2.

FIG. 2 is an illustrative example showing the unsupervised mapping of terms in a document to part of an ontology, specifying the documents-to-ontology distribution (Eq. 3). Two concepts have been labeled as +(nervous system) 202 and −(anatomical pathology) 204 from which an ontology-to-class distribution is induced. The mapping of a document to concepts is done in an automated fashion, using a named entity annotator in one embodiment of the present disclosure. Based on Eq. (4) this document would be labeled as Anatomical pathology. For instance, the text content 206 of the document includes more overlapping of words in the anatomical pathology 204 concept than the nervous system concept 202. In such as way, the present disclosure may map document to ontology.

The ontology mapped document then may be labeled with a class label based on the ontology-to-class mapping. For instance, the class label mapped to the ontology concept of the document is identified, and the document is labeled with the identified class label.

For specifying the ontology-to-class distribution, for instance, associated with Wikipedia™ ontology, the user may be allowed to search Wikipedia™ or browse the category tree and supply a collection of labeled concepts. Such category tree may be accessed via “http:// en.wikipedia.org/wiki/Special: CategoryTree”. The ontology-to-class distribution may be induced by identifying entities from the Wikipedia™ ontology in the documents to be labeled. If more entities are found from the sub-tree corresponding to one class (Class 1) as opposed to another class (Class 2), the document may be labeled as Class 1. If no entities belonging to the Wikipedia™ sub-tree of either class are found in the document, the document may not be labeled. The above-described ontology-to-class distribution procedure may be used to obtain a large number of labeled data from unlabeled examples, with which a multinomial Naive Bayes classifier may be trained with respect to bag-of-words representation, as in Eq. 1.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which - when loaded in a computer system - is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1.-3. (canceled)

4. A method for automated labeling of documents using ontology, comprising:
mapping automatically, by a processor, a document with a concept in an ontology;
receiving an ontology concepts-to-class label mapping; and
labeling the document with a class label automatically, by identifying a class associated with the concept in the ontology, based on the ontology concepts to class label mapping.

5. The method of claim 4, wherein the ontology concepts-to-class label mapping is performed under manual supervision.

6. The method of claim 4, wherein the mapping is performed autonomously without manual supervision.

7. The method of claim 4, wherein the mapping step includes a mapping function extracting one or more keywords in the document and associating said one or more keywords to one or more concepts in the ontology.

8. The method of claim 7, further including the mapping function mapping the document to an ontology concept based on said association of said one or more keywords to said one or more concepts in the ontology, wherein the ontology concept associated with most of the keywords in the document is selected as the concept to map to the document.

9. A computer-implemented method for automated labeling of documents using ontology, comprising:
generating a first mapping function for automatically mapping a plurality of documents each with a concept of an ontology to create a documents-to-ontology distribution;
receiving an ontology-to-class distribution that maps concepts in the ontology to class labels, respectively; and
generating a classifier that labels a selected document with an associated class identified based on the documents-to-ontology distribution and the ontology-to-class distribution.

10. The method of claim 9, wherein the generating steps are performed automatically by a processor.

11.- 1 5. (canceled)
